(19) United States
(12) Patent Application Publication
(10) Pub. No.: US 2002/0139032 A1
(43) Pub. Date: Oct. 3, 2002

(54) Flexible fish landing net

(76) Inventor: Phillip John Campbell, Raleigh, NC (US)

Correspondence Address: Phillip John Campbell, 9004 Stoney Run Drive, Raleiah, NC, 27615, US

(21) Appl. No.: 09/824,497

(22) Filed: Apr. 2, 2001

(51) Int. Cl. A01K 77/00

(52) U.S. Cl. 43/11

(57) ABSTRACT

A flexible fish landing net for use from a substantially elevated position relative to the water line(10) is provided which includes a netting material(15), flexible rim(20) having reinstating force and a connecting rope assembly(30) for raising and lowering the net. During use the flexible rim material deflects inwardly under application of weight in the net thereby reducing the exposure of the net aperture.

### BACKGROUND-FIELD OF THE INVENTION

The present invention relates to fish landing nets. And more specifically to a flexible fish landing net that is generally employed from an elevated disposition to the water line with a rope attachment as from a fishing pier, high dock, bridge or large boat. Pier and bridge nets, or drop nest as there are also called, are typically used when an angler catches a fish that is too heavy for the tackle that is on their rod and reel. The pier net is lowered to the water line where it is allowed to submerge slightly and the fish is guided inside the perimeter of the net and the net is then lifted by a rope attachment. If an attempt is made to bring a large fish up onto a pier deck with just the rod and reel the line may break and the fish could escape. Pier and bridge fish landing nets typically are constructed from rigid metal in the shape of a hoop or are hinged and joined together in such a fashion as to be foldable. The rigid hoop style pier net is large, typically 36″ inches in diameter, cumbersome, heavy and not easy to store or haul and the hinged type can be difficult to operate. U.S. Pat. No. 2,814,899 issued to Brosius on Dec. 3, 1957 shows a collapsible hoop net and collapsible hoop net with handle. This patent addresses compactibility but does not address rope attachments, use from elevated positions or the impact of excessive weight applications to the rim. U.S. Pat. No. 4,021,956 issued to Hogg on May 10, 1977 shows a fishing net with flexible framework that provides for resilient action but does not teach rope attachments or use from elevated positions

### OBJECTS AND ADVANTAGES

It is an object of the present invention to provide an improved fish landing net. It is another object of the invention to provide a flexible fish landing net that:

a. is compactible

b. easy to transport

c. can be utilized from an elevated position

d. is easy to deploy

e. is easy to use

f. enhances ensnaring over other types of nets

g. provides large weight carrying capabilities

h. is flexible yet maintains hoop memory

i. enhances stability

Typically a pier or bridge tackle shop will have a solid hoop net available for rent with a deposit. This net is often “in use” or hard to locate when a fisherman needs the service of the net. Fishing lines can get tangled and fish will be lost if the proper net is not available for service at the time a fish is ready to be landed.

Advantages of this device are the ability for even a novice fishermen to have at his or her immediate disposal a flexible compact yet fully deployable, convenient fish landing net that is essential for the landing of heavy fish when caught from an elevated location, one that also enhances stability and ensnaring capabilities.

The present invention also provides for a flexible hoop that deflects inwardly when a fish is ensnared in the net as weight is applied to the inside of the netting fabric bag during the landing effort. This inward deflection of the flexible hoop occurs at the rope connection points to effectively reduce the size of the aperture of the hoop thus further enclosing the fish in the net and preventing it from jumping out of the net. The net allows for quick and easy storing as it may be collapsed in a fashion similar to the storing of a band saw blade. That is to say, to be collapsed from one hoop down into smaller concentric hoops. The net can be used for all types, sizes and species of marine creatures.

A typical rigid hoop net can be unstable. The present invention increases stability. During use the generally circular net opening collapses inwardly effectively concentrating the pulling force of lifting the net in a direct and straight line fashion thereby centralizing the force of gravity on the device.

### DESCRIPTION OF DRAWINGS

FIG. 1 is a perspective view of a pier and bridge fish landing net in accordance with one embodiment of the present invention;

FIG. 2 is a perspective view of a pier and bridge fish landing net in use showing the inward deflection of the hoop when the weight of a catch is expressed on the hoop of the type shown in FIG. 1;

FIG. 3 is a plan view of the present invention in a stored condition;

FIG. 4 is a plan view of the hoop of the present invention showing the generally circular condition of the hoop prior to lifting;

FIG. 5 is a plan view of the hoop of the present invention showing the inward deflection of the flexible hoop material.

FIG. 6 is a side view with sectional cutaway in accordance with one embodiment of the present invention showing the flexible rim material housed in a fabric skirt material.

### DESCRIPTION OF FIGS

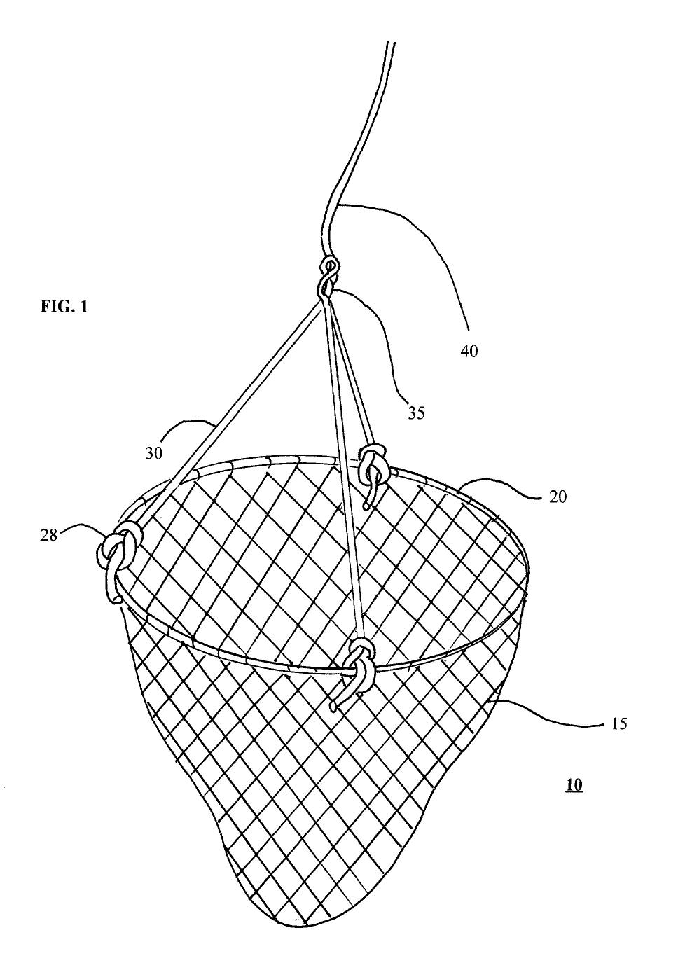

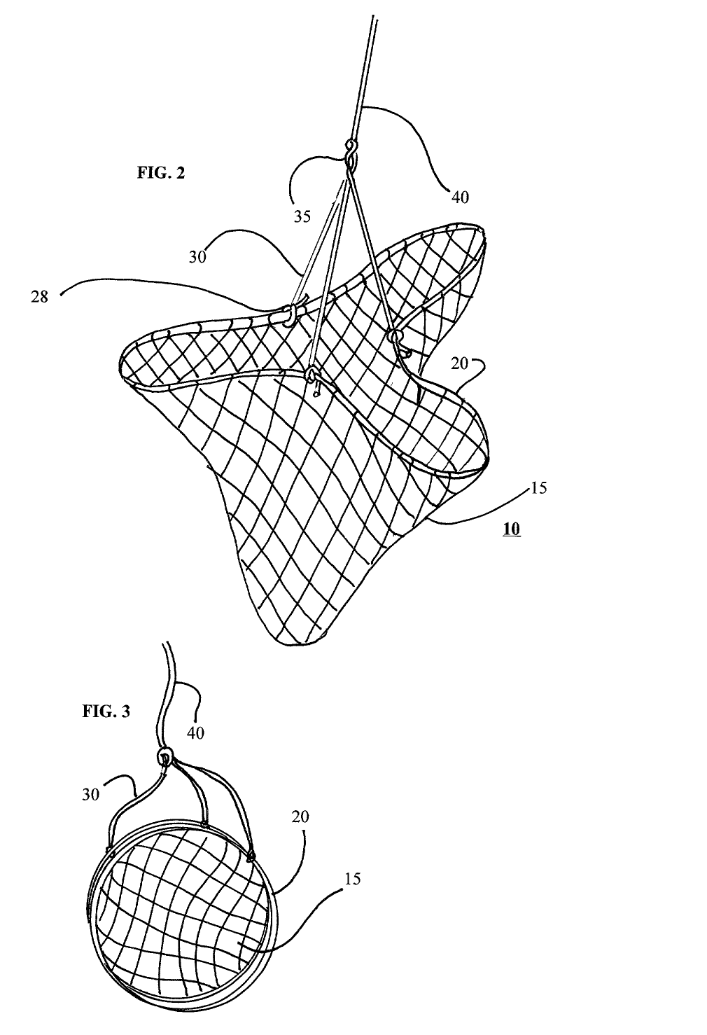

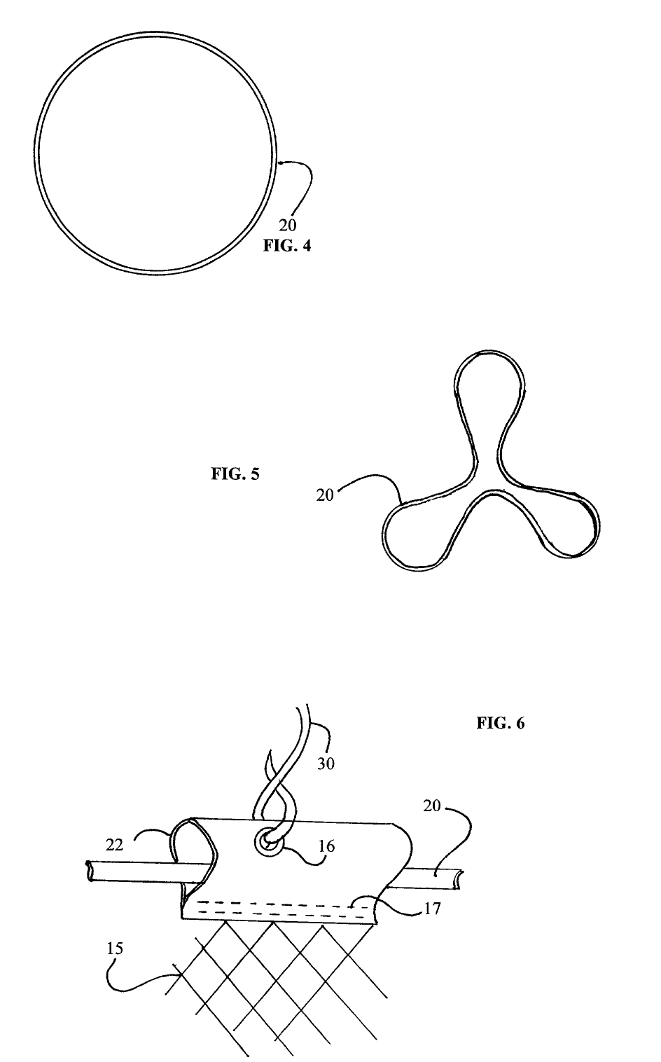

A typical embodiment of flexible pier and bridge fish landing net of the present invention is illustrated in FIGS. 1-2. Referring to FIG. 1 a fish landing net is shown comprising a netting material 15 attached to a generally circular flexible rim or hoop 20. The flexible hoop 20 may be made of any number of flexible yet memory retaining materials such as spring steel, fiberglass or carbon fiber. Three separate sections of rope 30 are attached at three equally spaced locations 28 on the flexible hoop 20. The opposite ends of attached ropes 30 come together or terminate at a single point of attachment 35 at a set distance above the hoop. A single rope 40 is attached at this termination point to provide a means of raising and lowering the net to the waterline from elevated positions. Referring to FIG. 2, FIG. 2 shows flexible landing net 10 during use. Flexible hoop 20 is shown deflecting inwardly, toward the center of the net at the three attachment points 28 as the force of weight is placed inside the net material. This inward deflection of hoop 20 effectively distorts the generally circular condition of hoop 20 causing the mouth opening of the net to become reduced. When the force of the weight is removed flexible hoop 20 returns to a generally circular disposition. FIG. 3 shows the fish landing net of the present invention in a compact or collapsed condition as it would be for transportation or storing prior to use. FIG. 4 shows the generally circular condition of the hoop 20 when deployed but not in use. FIG. 5 shows the hoop 20 during use where deflection occurs at the rope attachment points reducing the exposure of the net aperture. FIG. 6 shows an alternative embodiment of the present invention. Hoop 20 is shown enclosed in a fabric skirt 22. Fabric skirt 22 is sewn to net fabric 15 with a hem 17. Grommets 16 are provided passing through skirt 22 to allow for rope attachment 30 to be secured to the device.

### OPERATION

Operation and use of the device may be illustrated with reference to FIG. 1 & FIG. 3. FIG. 3 shows the fish landing net of the present invention in a compact or collapsed condition as it would be for transportation or storing prior to use. The user may deploy the device by pulling the spring loaded smaller hoop sections apart whereby the natural restoring force of hoop 20 will force the net to pop open. Referring to FIG. 1 the net may now be lifted by landing rope 40 and lowered to the water line for retrieving a catch.

### SUMMARY, RAMIFICATIONS, AND SCOPE

Accordingly the reader will see that the fish landing device of the present invention can be utilized in a variety of settings. In addition the present invention provides a flexible resilient hoop that lends greater stability and enhanced ensnaring capabilities.

While the present invention has been described with respect to the presented embodiments it is easily observed that variations and modifications may be introduced without departing from the true spirit and scope of this invention. For example the net mouth opening and flexible rim member may be provided in a shape other than that of a circle such as a triangle, diamond or oval.

What I claim is:

1. An improved fish landing net for use from a substantially elevated position relative to the waterline comprising: a flexible rim member having reinstating force, said rim member having supporting lines attached thereto and a net supported by said rim member, said rim member deflecting inwardly when pulling force is applied to said supporting lines and met with opposing resistance.

2. The fish landing net of claim 1, wherein said rim member is made of spring steel.

3. An improved fish landing net for use from a substantially elevated position relative to the waterline comprising: a flexible rim member having reinstating force, said rim member encased in a fabric skirt having supporting lines attached thereto and a net supported by said fabric skirt, said rim member deflecting inwardly when pulling force is applied to said supporting lines and met with opposing resistance.

4. The fish landing net of claim 3, wherein said rim member is made of spring steel.
